(19) United States
(12) Patent Application Publication
(10) Pub. No.: US 2017/0298487 A1
(43) Pub. Date: Oct. 19, 2017

(54) HIGH STRENGTH SPRING STEEL HAVING EXCELLENT CORROSION RESISTANCE

(71) Applicants: Hyundai Motor Company, Seoul (KR); Hyundai Steel Company, Incheon (KR)

(72) Inventors: Sung Chul Cha, Seoul (KR); Seung Hyun Hong, Seoul (KR); Ik Soo Kim, Yongin (KR); Kyu Ho Lee, Bucheon (KR)

(21) Appl. No.: 15/342,636

(22) Filed: Nov. 3, 2016

(30) Foreign Application Priority Data
Apr. 15, 2016 (KR) 10-2016-0046457

(51) Int. Cl. C22C 38/54; C22C 38/48; C22C 38/46; C22C 38/44; C22C 38/00; C22C 38/34; C22C 38/06; C22C 38/04; C22C 38/50; C22C 38/42

(52) U.S. Cl. CPC C22C 38/54; C22C 38/50; C22C 38/48; C22C 38/46; C22C 38/44; C22C 38/42; C22C 38/34; C22C 38/06; C22C 38/04; C22C 38/002; C22C 38/001; B60G 2206/72

(57) ABSTRACT

Disclosed herein is a steel composition with improvement in tensile strength and fatigue life, which can be used for a vehicle part such as a vehicle suspension system.

### CROSS REFERENCE TO RELATED APPLICATION

The present application claims priority to Korean Patent Application No. 10-2016-0046457, filed Apr. 15, 2016, the entire contents of which is incorporated herein for all purposes by this reference.

### TECHNICAL FIELD

The present invention relates to a steel composition having substantially improved strength and corrosion resistance. Accordingly, the steel composition may be suitably used in a vehicle suspension system with improvement in tensile strength and fatigue life.

### BACKGROUND OF THE INVENTION

Spring steel has been widely used in the manufacture of springs, prominently in vehicles and industrial suspension applications. For use in a car suspension system, spring steel is required to exhibit high fatigue strength.

Recently, weight reduction and high power have been required for vehicles with the aim of reducing exhaust emissions and improving fuel efficiency. Accordingly, the design of coil springs useful for engines or car suspension systems has been directed toward improving stress resistance.

Particularly, coil springs for use in car suspension systems are required to have excellent strength because these parts continuously endure loads. Further, corrosion resistance should be fully considered because they are exposed to an external environment.

Such coil springs for car suspension systems have been usually made of spring steel including mainly of carbon (C), silicon (Si), manganese (Mn), and chromium (Cr) has and having a tensile strength of about 1900 Mpa. Moreover, research has been conducted into an inclusion control technique in which kinds and contents of alloy elements are controlled to improve fatigue life.

The foregoing is intended merely to aid in the understanding of the background of the present invention, and is not intended to mean that the present invention falls within the purview of the related art that is already known to those skilled in the art.

### SUMMARY OF THE INVENTION

In preferred aspect, the present invention provides a high-strength spring steel that is improved in tensile strength by optimizing contents of molybdenum (Mo), nickel (Ni), vanadium (V), niobium (Nb), titanium (Ti), boron (B), and tungsten (W) and in fatigue strength under a corrosive environment by controlling inclusions formed therein.

In one aspect of the present invention, provided is a spring steel or its steel composition, which may be suitably used for a vehicle part such as a coil spring steel in a vehicle suspension system. Unless otherwise indicated hereinafter, the steel or steel composition may be used as a spring steel having substantially improved strength which can be used for a vehicle.

The steel composition may comprise: carbon (C) in an amount of about 0.4 to 0.9% by weight; silicon (Si) in an amount of about 1.3 to 2.3% by weight; manganese (Mn) in an amount of about 0.5 to 1.2% by weight; chromium (Cr) in an amount of about 0.6 to 1.2% by weight; molybdenum (Mo) in an amount of about 0.1 to 0.5% by weight; nickel (Ni) in an amount of about 0.05 to 0.8% by weight; vanadium (V) in an amount of about 0.05 to 0.5% by weight; niobium (Nb) in an amount of about 0.05 to 0.5% by weight; titanium (Ti) in an amount of about 0.05 to 0.3% by weight; boron (B) in an amount of about 0.001 to 0.01% by weight; tungsten (W) in an amount of about 0.01 to 0.52% by weight; copper (Cu) in an amount of about 0.3% by weight or less but greater than 0% by weight; aluminum (Al) in an amount of about 0.3% by weight or less but greater than 0% by weight; nitrogen (N) in an amount of about 0.03% by weight or less but greater than 0% by weight; oxygen (O) in an amount of about 0.003% by weight or less but greater than 0% by weight; iron (Fe) constituting the remaining balance of the steel composition. Unless otherwise indicated herein, all % by weights based on the total weigh of the steel composition.

Further provided is a steel composition that may consist essentially of, essentially consist of or consist of the components as described herein. For example, the steel composition may consist essentially of, essentially consist of, or consist of: carbon (C) in an amount of about 0.4 to 0.9% by weight; silicon (Si) in an amount of about 1.3 to 2.3% by weight; manganese (Mn) in an amount of about 0.5 to 1.2% by weight; chromium (Cr) in an amount of about 0.6 to 1.2% by weight; molybdenum (Mo) in an amount of about 0.1 to 0.5% by weight; nickel (Ni) in an amount of about 0.05 to 0.8% by weight; vanadium (V) in an amount of about 0.05 to 0.5% by weight; niobium (Nb) in an amount of about 0.05 to 0.5% by weight; titanium (Ti) in an amount of about 0.05 to 0.3% by weight; boron (B) in an amount of about 0.001 to 0.01% by weight; tungsten (W) in an amount of about 0.01 to 0.52% by weight; copper (Cu) in an amount of about 0.3% by weight or less but greater than 0% by weight; aluminum (Al) in an amount of about 0.3% by weight or less but greater than 0% by weight; nitrogen (N) in an amount of about 0.03% by weight or less but greater than 0% by weight; oxygen (O) in an amount of about 0.003% by weight or less but greater than 0% by weight; iron (Fe) constituting the remaining balance of the steel composition.

In some embodiments, the steel composition suitably may have a tensile strength of about 2100 MPa or greater.

In some embodiments, the steel composition suitably may have a hardness of about 700 HV.

In some embodiments, the steel composition suitably may have a corrosion pit depth of about 20 μm or less.

In some embodiments, the steel composition suitably may have a fatigue life of about 280,000 cycles or greater as measured by a bending fatigue test.

In some embodiments, the steel composition suitably may have a fatigue life of 25,000 cycles or greater as measured by a single corrosion fatigue life test.

In some embodiments, the steel composition suitably may have a fatigue life of 300,000 cycles or greater as measured by a complex corrosion fatigue test.

In another aspect, the present invention may provide a vehicle part comprising the steel composition as described herein. Exemplary vehicle part may include a spring steel used in a suspension system in a vehicle.

Other aspects of the invention are disclosed infra.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a graph showing the phase transformation of an exemplary steel composition based on a temperature change according to an exemplary embodiment of the present invention; and

FIG. 2 is a graph showing the phase transformation into cementite against temperature of an exemplary steel composition according to an exemplary embodiment of the present invention.

### DESCRIPTION OF THE PREFERRED EMBODIMENTS

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

For illustrative purposes, the principles of the present invention are described with reference to various exemplary embodiments. Although certain embodiments of the invention are specifically described herein, one of ordinary skill in the art will readily recognize that the same principles are equally applicable to, and can be employed in, other systems and methods. Before explaining the disclosed embodiments of the present invention in detail, it is to be understood that the invention is not limited in its application to the details of any particular embodiment shown.

In an exemplary embodiment, provided is a spring steel or a steel composition thereof, which may be suitable for use as a coil spring steel in a vehicle engine. In particular, the steel composition may have improved properties such as tensile strength and fatigue strength as components and contents thereof may be optimized.

The steel composition according to an exemplary embodiment of the present invention may comprise: carbon (C) in an amount of about 0.4 to 0.9% by weight; silicon (Si) in an amount of about 1.3 to 2.3% by weight; manganese (Mn) in an amount of about 0.5 to 1.2% by weight; chromium (Cr) in an amount of about 0.6 to 1.2% by weight; molybdenum (Mo) in an amount of about 0.1 to 0.5% by weight; nickel (Ni) in an amount of about 0.05 to 0.8% by weight; vanadium (V) in an amount of about 0.05 to 0.5% by weight; niobium (Nb) in an amount of about 0.05 to 0.5% by weight; titanium (Ti) in an amount of about 0.05 to 0.3% by weight; boron (B) in an amount of about 0.001 to 0.01% by weight; tungsten (W) in an amount of about 0.01 to 0.52% by weight; copper (Cu) in an amount of about 0.3% by weight or less but greater than 0% by weight; aluminum (Al) in an amount of about 0.3% by weight or less but greater than 0% by weight; nitrogen (N) in an amount of about 0.03% by weight or less but greater than 0% by weight; oxygen (O) in an amount of about 0.003% by weight or less but greater than 0% by weight; iron (Fe) constituting the remaining balance of the steel composition.Below, reasons for numerical limitations of the components in the composition according to the present invention will be described. Unless described otherwise, the unit % by weight given in the following description is based on the total weight of the steel composition.

Carbon (C) as used herein may be included in an amount of about 0.4 to 0.9% by weight. The strength of steel may increase with increased carbon content. When the carbon content is less than about 0.4% by weight, the steel composition may have only slightly increased strength because of insufficient quenching properties upon heat treatment. On the other hand, when the carbon content is greater than about 0.9% by weight, formation of the martensitic phase may be induced upon quenching, thereby resulting in decreased fatigue strength and toughness. Preferably, in the above range, the steel composition may be imparted with substantially improved strength and ductility.

Silicon (Si) as used herein may be included in an amount of about 1.3 to 2.3% by weight. When a solid solution is formed in ferrite with iron, silicon may increase strength and temper softening resistance. When the silicon content is less than about 1.3% by weight, the steel composition may have reduced temper softening resistance. On the other hand, when the silicon content is greater than about 2.3% by weight, decarburizing may occur upon heat treatment.

Manganese (Mn) as used herein may be included contained in an amount of about 0.5 to 1.2% by weight. When a solid solution is formed in the matrix, manganese may improve bending fatigue strength and quenching properties. When the content of manganese is in an amount less than about 0.5% by weight, manganese may not have sufficient quenching properties. When the manganese content is greater than about 1.2% by weight, toughness may deteriorate.

Chromium (Cr) as used herein may be included in an amount of about 0.6 to 1.2% by weight. Chromium may induce the formation of carbide deposits, improve toughness upon tempering, improve hardenability, and increase strength by suppressing softening. In addition, chromium may improve toughness of the steel composition through microstructural refinement. when the chromium content is of about 0.6% by weight or greater, chromium may improve temper softening, decarburizing, quenching, and corrosion resistance When the content of chromium is greater than about 1.2% by weight, large grain boundary carbides may be formed excessively, thereby deteriorating strength and increase in brittleness.

Molybdenum (Mo) as used herein may be included in an amount of about 0.1 to 0.5% by weight. Like chromium, molybdenum may form microstructural carbide deposits to improve strength and fracture toughness. Particularly, the uniform formation of about 1 to 5 nm of titanium molybdenum carbide (TiMoC) may improve tempering resistance and ensure thermal resistance and high strength. When the content thereof is less than about 0.1% by weight, molybdenum may not form carbides, thereby failing to obtain sufficient strength. On the other hand, when the molybdenum content is greater than about 0.5% by weight, manufacturing cost may not be efficient since the carbide deposits and the strength improvement effects are already saturated.

Nickel (Ni) as used herein may be included in an amount of about 0.05 to 0.8% by weight. Nickel may improve corrosion resistance of steel and improve thermal resistance, cold shortness, hardenability, dimensional stability, and settability. When the nickel content is less than about 0.05% by weight, the steel composition may deteriorate in corrosion resistance and high-temperature stability. On the other hand, the steel composition may undergo red shortness when the nickel content is greater than about 0.8% by weight.

Vanadium (V) as used herein may be included in an amount of about 0.05 to 0.5% by weight. Vanadium may improve micro structural refinement, tempering resistance, dimensional stability, and settability, and brings about thermal resistance and high strength. In addition, vanadium may form a microstructural deposit vanadium carbide (VC) to increase fractural toughness. Particularly, the microstructural deposit VC may retain the migration of grain boundaries. V may be dissolved upon austenitizing to form a solid solution, and may be deposited upon tempering thereby causing secondary hardening. When the vanadium content is less than about 0.05% by weight, the fractural toughness may not be prevented from decreasing. When the vanadium content is greater than about 0.5% by weight, the steel composition may contain coarse deposits and decrease in strength after quenching.

Niobium (Nb) as used herein may be included in an amount of about 0.05 to 0.5% by weight. Niobium may include microstructural refinement, harden the steel surface through nitrization, and improve dimensional stability and settability. The formation of niobium carbide (NbC) may increase the steel strength and control the formation rates of other carbides (e.g. CrC, VC, TiC, MoC). When the niobium content is less than about 0.05% by weight, the steel composition may decrease in strength and may have a non-uniform distribution of the carbide. When the niobium content is greater than 0.5% by weight, the formation of other carbides may be restrained.

Titanium (Ti) as used herein may be included in an amount of about 0.05 to 0.3% by weight. Like Nb, and Al, titanium may prevent or restrain grain recrystallization and growth. In addition, titanium may form nanocarbides such as titanium carbide (TiC), titanium molybdenum carbide (TiMoC) and the like, and may react with nitrogen to form titanium nitride (TiN), which may restrain grain growth. Further, it may form titanium boride (TiB₂), which may interfere with binding between B and N, with the consequent minimization of the BN-induced quenching property degradation. When the titanium content is less than about 0.0 5% by weight, other inclusions such as Al₂O₃ may be formed, thereby decreasing fatigue endurance. When the titanium content is greater than about 0.3% by weight, other alloy elements may be interfered and costs may increase.

Boron (B) as used herein may be included in an amount of about 0.001 to 0.01% by weight.

Boron may improve tensile strength and elongation, prevent corrosion, and increase corrosion resistance and impact resistance. When the boron content is less than about 0.001% by weight, the steel composition may have reduced strength. On the other hand, when the boron content is greater than about 0.01% by weight, toughness may be decreased, thereby reducing resistance for the steel composition.

Tungsten (W) as used herein may be included in an amount of about 0.01 to 0.52% by weight. Tungsten may form carbide deposits, thereby improving high-temperature wear resistance and toughness, restraining structural growth, and reducing scale resistance. When the content of tungsten is less than about 0.01% by weight, a desired degree of high-temperature wear resistance may not be maintained while the formation of the carbides is reduced. When the content of tungsten is greater than about 0.52% by weight, excessive tungsten carbide (WC) may be formed, thereby deteriorating toughness.

Copper (Cu) as used herein may be included in an amount of about 0.3% by weight or less but greater than 0% by weight. Copper may increase quenching properties and strength after tempering, and, like Ni, may improve the corrosion resistance of the steel composition. The copper content may be advantageously limited to about 0.3% or less since excess copper increases production costs.

Aluminum (Al) as used herein may be included in an amount of about 0.3% by weight or less but greater than 0% by weight. Aluminum may form aluminum nitride (AlN) with nitrogen to induce the refinement of austenite and to improve strength and impact toughness. Particularly, addition of aluminum to the steel composition together with Nb, Ti, and Mo may reduce the amount of expensive elements, including vanadium for microstructural refinement and nickel for toughness improvement. However, the content of aluminum may be limited to about 0.3% by weight or less since an excess of aluminum may deteriorate the steel composition.

Nitrogen (N) as used herein may be included in an amount of about 0.03% by weight or less but greater than 0% by weight. Nitrogen may form aluminum nitride (AlN) and titanium nitride (TiN) with Al and Ti, respectively, thereby providing micro structural refinement. Particularly, TiN may improve the quenching property of boron. However, the nitrogen content may be advantageously limited to about 0.03% by weight or less since an excess of nitrogen reacts with boron, with the consequent reduction of quenching properties.

Oxygen (O) as used herein may be included in an amount of 0.003% by weight or less but greater than 0% by weight. Oxygen may bind to Si or Al to form non-metallic, oxide-based inclusions, thereby inducing a decrease in fatigue life property. Hence, a less amount of oxygen may provide better effects. In this invention, an oxygen content may be limited to 0.003% by weight.

In addition to the aforementioned components, the spring steel may comprise iron (Fe) constituting the remaining balance of the steel composition

### EXAMPLE

Below, a detailed description will be given with reference to Examples and Comparative Examples.

The spring steels of Examples and Comparative Examples were made under conditions suitable for the production of commercially available spring steels. Wire rods from molten steels in which components were used at various contents, as shown in the steel composition as indicated in the following Table 1 were prepared into steel wires through consecutive processes of isothermal treatment, wire drawing, quenching-tempering, and solder quenching. Briefly, the wire rods were maintained at a temperature of 940 to 960° C. for 3 to 5 minutes, cooled to a temperature of 640 to 660° C. and maintained at that temperature for 2-4 minutes, followed by cooling to a temperature of 18 to 22° C. for 0.5 to 1.5 minutes. This isothermal treatment was adapted to facilitate the subsequent wire drawing process. Through the thermal treatment, pearlite was formed in the wire rods.

TABLE 1

| wt. % | C | Si | Mn | Cr | Mo | Ni | V | Nb | Ti | B | W | Cu | Al | N | O |
|---|---|---|---|---|---|---|---|---|---|---|---|---|---|---|---|
| Conventional | 0.55 | 1.45 | 0.68 | 0.71 | — | 0.23 | 0.08 | — | 0.03 | — | — | 0.23 | 0.035 | — | — |
| (SUPM12C) | | | | | | | | | | | | | | | |
| Ex. 1 | 0.54 | 1.54 | 0.66 | 0.91 | 0.11 | 0.33 | 0.18 | 0.06 | 0.07 | 0.003 | 0.02 | 0.054 | 0.008 | 0.0011 | 0.0007 |
| Ex. 2 | 0.65 | 2.26 | 0.74 | 0.62 | 0.31 | 0.07 | 0.07 | 0.22 | 0.16 | 0.002 | 0.33 | 0.067 | 0.014 | 0.0012 | 0.0011 |
| EX. 3 | 0.87 | 1.83 | 1.15 | 1.16 | 0.49 | 0.79 | 0.48 | 0.48 | 0.28 | 0.009 | 0.51 | 0.043 | 0.013 | 0.0017 | 0.0014 |
| C. Ex. 1 | 0.59 | 1.54 | 0.64 | 0.94 | 0.09 | 0.36 | 0.15 | 0.08 | 0.06 | 0.004 | 0.09 | 0.052 | 0.004 | 0.0015 | 0.0005 |
| C. Ex. 2 | 0.68 | 2.25 | 0.72 | 0.78 | 0.52 | 0.73 | 0.18 | 0.24 | 0.18 | 0.002 | 0.33 | 0.065 | 0.014 | 0.0016 | 0.00086 |
| C. Ex. 3 | 0.81 | 1.82 | 1.18 | 1.14 | 0.45 | 0.04 | 0.43 | 0.48 | 0.28 | 0.006 | 0.52 | 0.042 | 0.011 | 0.0017 | 0.0012 |
| C. Ex. 4 | 0.52 | 1.57 | 0.64 | 0.82 | 0.15 | 0.82 | 0.39 | 0.08 | 0.12 | 0.003 | 0.06 | 0.054 | 0.007 | 0.0013 | 0.0009 |
| C. Ex. 5 | 0.67 | 2.16 | 0.75 | 0.76 | 0.33 | 0.34 | 0.03 | 0.21 | 0.18 | 0.004 | 0.35 | 0.067 | 0.014 | 0.0015 | 0.0006 |
| C. Ex. 6 | 0.87 | 1.76 | 1.15 | 1.13 | 0.45 | 0.78 | 0.54 | 0.48 | 0.27 | 0.007 | 0.44 | 0.043 | 0.013 | 0.0014 | 0.0008 |
| C. Ex. 7 | 0.68 | 2.28 | 0.73 | 0.78 | 0.14 | 0.38 | 0.46 | 0.04 | 0.08 | 0.004 | 0.22 | 0.046 | 0.011 | 0.0012 | 0.001 |
| C. Ex. 8 | 0.83 | 1.87 | 1.15 | 1.19 | 0.35 | 0.72 | 0.19 | 0.52 | 0.16 | 0.003 | 0.35 | 0.054 | 0.008 | 0.0011 | 0.0007 |
| C. Ex. 9 | 0.46 | 1.58 | 0.69 | 0.93 | 0.19 | 0.38 | 0.14 | 0.26 | 0.04 | 0.008 | 0.5 | 0.067 | 0.013 | 0.0012 | 0.0013 |
| C. Ex. 10 | 0.88 | 2.28 | 0.76 | 0.74 | 0.38 | 0.74 | 0.47 | 0.15 | 0.32 | 0.004 | 0.03 | 0.043 | 0.012 | 0.0017 | 0.0014 |
| C. Ex. 11 | 0.61 | 1.49 | 0.88 | 0.73 | 0.13 | 0.39 | 0.42 | 0.47 | 0.09 | 0.0009 | 0.34 | 0.068 | 0.014 | 0.0015 | 0.0013 |
| C. Ex. 12 | 0.66 | 1.83 | 1.18 | 1.17 | 0.36 | 0.71 | 0.33 | 0.09 | 0.15 | 0.011 | 0.5 | 0.065 | 0.015 | 0.0016 | 0.0009 |
| C. Ex. 13 | 0.52 | 1.94 | 0.97 | 0.96 | 0.19 | 0.36 | 0.46 | 0.28 | 0.16 | 0.005 | 0.008 | 0.046 | 0.011 | 0.0017 | 0.0012 |
| C. Ex. 14 | 0.58 | 1.68 | 0.78 | 0.79 | 0.38 | 0.73 | 0.44 | 0.16 | 0.27 | 0.001 | 0.34 | 0.053 | 0.008 | 0.0011 | 0.0009 |

After the isothermal treatment, the wire rods were subjected to various steps of wire drawing to achieve a target wire diameter. In the present invention, wire rods having a diameter of 4 mm were drawn.

The drawn wire rods were heated to and maintained at a temperature 940 to 960° C. for 3 to 5 minutes, and quenched at a temperature of 45 to 55° C., followed by tempering for 0.5 to 1.5 minutes. Thereafter, the wire rods were again heated to a temperature of 440 to 460° C. and maintained for 2 to 4 minutes, and then subjected to solder quenching. The formation of martensite by quenching and tempering imparted strength to the wire rods while the formation of tempered martensite by solder quenching imparted strength and toughness.

In Test Examples, an examination was made of the physical properties of the spring steels of Examples and Comparative Examples.

The spring steels of Examples and Comparative Examples were tested for tensile strength, hardness, fatigue life of wire rods, corrosion pit depth, single corrosion fatigue life, complex corrosion fatigue life, and improvement in carbon fraction and carbon activity, and the results are given in the following Table 2.

TABLE 2

| | | | | | Single | Complex | |
|---|---|---|---|---|---|---|---|
| | | | | | Corrosion | Corrosion | Carbon |
| | Tensile. | | Wire Rod | Corrosion | Fatigue Life | Fatigue Life | Fraction > 7% |
| | Strength | Hardness | Fatigue Life | pit | (Salt Spray + | (ES Complex | Carbon |
| | (MPa) | (HV) | (cycles) | depth (μm) | Fatigue) (cycles) | Corrosion)(cycles) | Activity > 3% |
| Conventional | 1960 | 570 | 220,000 | 24 | 17,000 | 275,000 | X |
| (SUPM12C) | | | | | | | |
| Ex. 1 | 2190 | 710 | 300,000 | 17 | 27,000 | 387,000 | ◯ |
| Ex. 2 | 2215 | 730 | 325,000 | 14 | 29,000 | 396,000 | ◯ |
| Ex. 3 | 2205 | 727 | 313,000 | 13 | 30,000 | 398,000 | ◯ |
| C. Ex. 1 | 1965 | 630 | 180,000 | 27 | 19,000 | 284,000 | X |
| C. Ex. 2 | 2040 | 590 | 200,000 | 25 | 16,000 | 266,000 | ◯ |
| C. Ex. 3 | 1890 | 610 | 220,000 | 27 | 15,000 | 273,000 | ◯ |
| C. Ex. 4 | 1785 | 585 | 210,000 | 23 | 21,000 | 265,000 | ◯ |
| C. Ex. 5 | 2015 | 615 | 250,000 | 24 | 22,000 | 267,000 | X |
| C. Ex. 6 | 2020 | 630 | 240,000 | 27 | 17,000 | 293,000 | ◯ |
| C. Ex. 7 | 2005 | 635 | 260,000 | 27 | 23,000 | 284,000 | X |
| C. Ex. 8 | 2055 | 645 | 210,000 | 24 | 22,000 | 289,000 | ◯ |
| C. Ex. 9 | 2095 | 660 | 190,000 | 23 | 18,000 | 277,000 | X |
| C. Ex. 10 | 1830 | 650 | 180,000 | 22 | 19,000 | 265,000 | ◯ |
| C. Ex. 11 | 1860 | 570 | 230,000 | 26 | 16,000 | 271,000 | ◯ |
| C. Ex. 12 | 1770 | 560 | 220,000 | 25 | 17,000 | 261,000 | ◯ |
| C. Ex. 13 | 2015 | 610 | 230,000 | 28 | 18,000 | 291,000 | X |
| C. Ex. 14 | 2035 | 620 | 250,000 | 27 | 21,000 | 251,000 | ◯ |

In this regard, tensile strength was measured using a 20-ton tester on specimens with a diameter of 4 mm according to KS B 0802, and hardness was measured using a micro Vickers hardness tester at 300 gf according to KS B 0811.

Fatigue life was measured by performing a rotary bending fatigue test on specimens with a diameter of 4 mm according to KS B ISO 1143. L10 life, referred to as “basic rating life”, was defined as the lifetime associated with 90% reliability when operating under conventional conditions, and was expressed by round numbers in multiples of one million. The 10 percent life was approximately one-seventh of the L50 mean life or mean time between failures. Corrosion fatigue life was measured using a salt spray test (KS D 9502, ISO 3768/7263).

Improvements in carbon fraction and carbon activity were calculated using ThermoCalc with reference to thermodynamic databases. Particularly, the carbon fraction was measured through counting on SEM-EDX elemental maps.

As is understood from the data of Table 2, the conventional steel that lacked Mo, Ni, V, Nb, Ti, B, and W did not meet any of the requirements of the present invention for tensile strength, hardness, fatigue life of wire rods, corrosion pit depth, single corrosion fatigue life, complex corrosion fatigue life, and improvement in carbon fraction and carbon activity.

The steels of Comparative Examples 1 to 14 were different in component content from those according to the present invention, and failed to meet any of the requirements of the present invention, although improving somewhat in tensile strength, hardness, fatigue life of wire rods, corrosion pit depth, single corrosion fatigue life, complex corrosion fatigue life, and improvement in carbon fraction and carbon activity.

Failing to acquire sufficient tensile strength, particularly, the steel of Comparative Example 1, which included less amount of Mo, did not secure sufficient tensile strength, and was deteriorated in the fatigue life of wire rods and aggravated in corrosion pit depth, compared to the conventional steel.

In Comparative Examples 3 and 11, each of the Ni and the B content was less than the predetermined amounts in the present invention. The steels rather decreased in single corrosion fatigue life, compared to the conventional steel.

In Comparative Example 9, the Ti content was less than the predetermined amount in the present invention. The steel rather decreased in the fatigue life of wire rods because other inclusions such as Al₂O₃ are formed to decrease fatigue endurance.

On the other hand, all of the steels of Examples 1 to 3 that satisfied the predetermined ranges in the present invention showed a tensile strength of 2100 MPa or greater and a hardness of 700HV or greater. In addition, corrosion pits with a depth of 20 μm or less were measured in the steels. They were found to have a fatigue life over 280,000 cycles as measured by a bending fatigue test, 25,000 cycles as measured by a single corrosion fatigue test, and 300,000 cycles as measured by a complex corrosion fatigue test. Also, they improved in carbon fraction by 7% or greater and in carbon activity by 3% or greater, compared to the conventional steel.

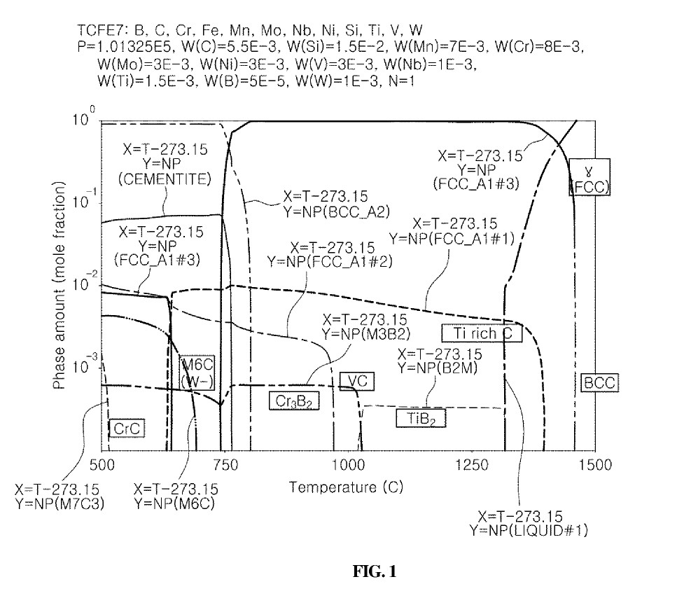

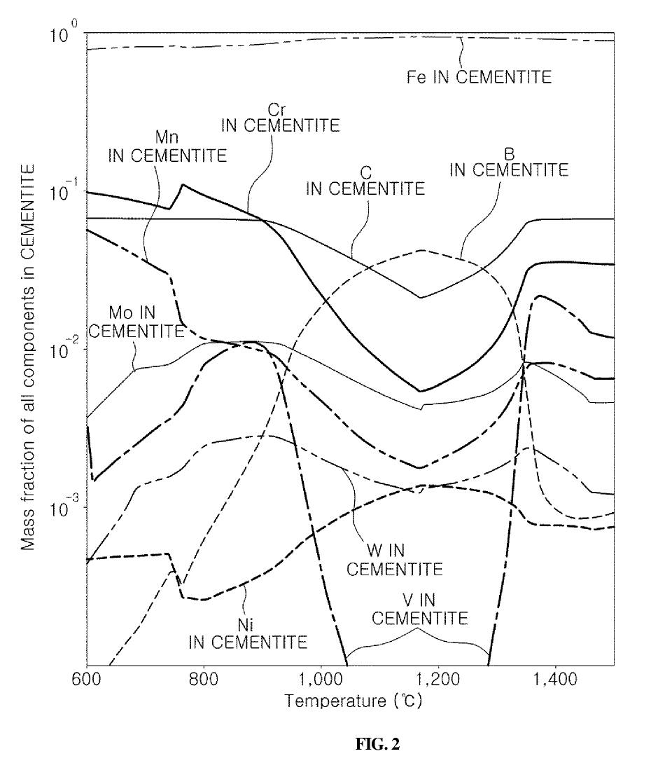

FIG. 1 is a graph showing the phase transformation of an exemplary spring steel against temperature according to an exemplary embodiment of the present invention, and FIG. 2 is a graph showing the phase transformation into cementite against temperature of an exemplary spring steel according to an exemplary embodiment of the present invention.

In FIG. 1, the phase transformation of a steel having an alloy composition of Fe-1.5Si-0.7Mn-0.8Cr-0.3Ni-0.3Mo-0.3V-0.1Nb-0.15Ti-0.003B-0.1W-0.55C is shown against temperature. Given the alloy composition of the present invention, as shown in FIG. 1, the steel has various microinclusions such as FeMoWC, Cr₃B₂, and TiB₂, and thus was expected to be improved in strength and fatigue life.

In FIG. 2, the phase transformation of a steel having an alloy composition of Fe-1.5Si-0.7Mn-0.8Cr-0.3Ni-0.3Mo-0.3V-0.1Nb-0.15Ti-0.005B-0.1W-0.55C in cementite is shown against temperature. As shown in FIG. 2, it is understood that the complex behavior of nonary elements in cementite occurs, thus predicting the uniform distribution of microcarbides.

As described hitherto, the steel composition of the present invention may be provided with a tensile strength of 21,000 MPa or greater by optimizing contents of main alloy components and improved in corrosion resistance and complex corrosion fatigue life by 40% or greater through inclusion refinement.

Although the various exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A steel composition, comprising:
carbon (C) in an amount of about 0.4 to 0.9% by weight;
silicon (Si) in an amount of about 1.3 to 2.3% by weight;
manganese (Mn) in an amount of about 0.5 to 1.2% by weight;
chromium (Cr) in an amount of about 0.6 to 1.2% by weight;
molybdenum (Mo) in an amount of about 0.1 to 0.5% by weight;
nickel (Ni) in an amount of about 0.05 to 0.8% by weight;
vanadium (V) in an amount of about 0.05 to 0.5% by weight;
niobium (Nb) in an amount of about 0.05 to 0.5% by weight;
titanium (Ti) in an amount of about 0.05 to 0.3% by weight;
boron (B) in an amount of about 0.001 to 0.01% by weight;
tungsten (W) in an amount of about 0.01 to 0.52% by weight
copper (Cu) in an amount of about 0.3% by weight or less but greater than 0% by weight;
aluminum (Al) in an amount of about 0.3% by weight or less but greater than 0% by weight;
nitrogen (N) in an amount of about 0.03% by weight or less but greater than 0% by weight;
oxygen (O) in an amount of about 0.003% by weight or less but greater than 0% by weight;
iron (Fe) constituting the remaining balance of the steel composition,
all % by weight based on the total weigh of the steel composition.

2. The steel composition of claim 1, wherein the steel has a tensile strength of about 2100 MPa or greater.

3. The steel composition of claim 1, wherein the steel has a hardness of about 700 HV or greater.

4. The steel composition of claim 1, wherein the steel has a corrosion pit depth of about 20 μm or less.

5. The steel composition of claim 1, wherein the steel has a fatigue lifetime of about 280,000 cycles or greater as measured by a bending fatigue test.

6. The steel composition of claim 1, wherein the steel has a fatigue lifetime of about 25,000 cycles or greater as measured by a single corrosion fatigue life test.

7. The steel composition of claim 1, wherein the steel has a fatigue lifetime of about 300,000 cycles or greater as measured by a complex corrosion fatigue test.

8. The steel composition of claim 1, consisting essentially of:
carbon (C) in an amount of about 0.4 to 0.9% by weight;
silicon (Si) in an amount of about 1.3 to 2.3% by weight;
manganese (Mn) in an amount of about 0.5 to 1.2% by weight;
chromium (Cr) in an amount of about 0.6 to 1.2% by weight;
molybdenum (Mo) in an amount of about 0.1 to 0.5% by weight;
nickel (Ni) in an amount of about 0.05 to 0.8% by weight;
vanadium (V) in an amount of about 0.05 to 0.5% by weight;
niobium (Nb) in an amount of about 0.05 to 0.5% by weight;
titanium (Ti) in an amount of about 0.05 to 0.3% by weight;
boron (B) in an amount of about 0.001 to 0.01% by weight;
tungsten (W) in an amount of about 0.01 to 0.52% by weight
copper (Cu) in an amount of about 0.3% by weight or less but greater than 0% by weight;
aluminum (Al) in an amount of about 0.3% by weight or less but greater than 0% by weight;
nitrogen (N) in an amount of about 0.03% by weight or less but greater than 0% by weight;
oxygen (O) in an amount of about 0.003% by weight or less but greater than 0% by weight;
iron (Fe) constituting the remaining balance of the steel composition,
all % by weight based on the total weigh of the steel composition.

9. The steel composition of claim 1, consisting of:
carbon (C) in an amount of about 0.4 to 0.9% by weight;
silicon (Si) in an amount of about 1.3 to 2.3% by weight;
manganese (Mn) in an amount of about 0.5 to 1.2% by weight;
chromium (Cr) in an amount of about 0.6 to 1.2% by weight;
molybdenum (Mo) in an amount of about 0.1 to 0.5% by weight;
nickel (Ni) in an amount of about 0.05 to 0.8% by weight;
vanadium (V) in an amount of about 0.05 to 0.5% by weight;
niobium (Nb) in an amount of about 0.05 to 0.5% by weight;
titanium (Ti) in an amount of about 0.05 to 0.3% by weight;
boron (B) in an amount of about 0.001 to 0.01% by weight;
tungsten (W) in an amount of about 0.01 to 0.52% by weight;
copper (Cu) in an amount of about 0.3% by weight or less but greater than 0% by weight;
aluminum (Al) in an amount of about 0.3% by weight or less but greater than 0% by weight;
nitrogen (N) in an amount of about 0.03% by weight or less but greater than 0% by weight;
oxygen (O) in an amount of about 0.003% by weight or less but greater than 0% by weight;
iron (Fe) constituting the remaining balance of the steel composition,
all % by weights based on the total weigh of the steel composition.

10. A vehicle part comprising a steel composition of claim 1.

11. The vehicle part of claim 10 is a spring steel used in a suspension system in a vehicle.
